(19) United States
(12) Patent Application Publication
(10) Pub. No.: US 2008/0266330 A1
(43) Pub. Date: Oct. 30, 2008

(54) DISPLAY DEVICE AND DRIVING METHOD THEREOF

(75) Inventors: Kyong-Tae PARK, Gyeonggi-do (KR); Alexander ARKHIPOV, Gyeonggi-do (KR); Beohm-Rock CHOI, Seoul (KR); Young-Rok SONG, Gyeonggi-do (KR)

Correspondence Address: CANTOR COLBURN, LLP, 20 Church Street, 22nd Floor, Hartford, CT, 06103, US

(73) Assignee: SAMSUNG ELECTRONICS CO., LTD., Gyeonggi-do (KR)

(21) Appl. No.: 11/951,428

(22) Filed: Dec. 6, 2007

(30) Foreign Application Priority Data
Apr. 27, 2007 (KR) 10-2007-0041299

(51) Int. Cl. G09G 3/28

(52) U.S. Cl. 345/690

(57) ABSTRACT

A display device includes pixels which represent first, second and third colors and white, a signal controller which operates a white initial luminance value of the white and first, second and third luminance compensation values of the first, second and third colors based on input image signals of the first, second and third colors, generates a white output image signal of the white based on a sum of at least one portion of the first, second and third luminance compensation values and the white initial luminance value, and generates first, second and third output image signals of the first, second and third colors based on remaining first, second and third luminance compensation values, and a data driver which converts the white output image signal and the first, second and third output image signals into data voltages and supplies the data voltages to the pixels to display an image.

This application claims priority to Korean Patent Application No. 10-2007-0041299 filed, on Apr. 27, 2007, and all the benefits accruing therefrom under 35 U.S.C. §119, the contents of which in its entirety are herein incorporated by reference.

### BACKGROUND OF THE INVENTION

1. Field of the Invention

The present invention relates to a display device and a driving method thereof.

2. Description of the Related Art

Recently, flat panel displays which may replace cathode ray tubes (“CRTs”) have been actively researched. The flat panel displays include a plurality of pixels arranged in a matrix form and respectively representing one of three primary colors. One color is determined by combining the three primary colors emitting from three pixels, and the flat panel displays display desired images by appropriately controlling a luminance of each pixel.

However, when an image is displayed with only three pixels for the three primary colors, light efficiency may be deteriorated. Particularly, in organic light emitting devices (“OLEDs”), light emitting efficiency of an emission layer may be further deteriorated as an emission layer material of an organic light emitting diode changes according to a color.

Accordingly, a technology of adding a white pixel emitting white light in addition to the three primary color pixels has been suggested.

A four color display device including the white pixel and the three primary color pixels receives input image signals for the three primary color pixels, for example three pixels (red, green, and blue pixels) for red, green, and blue colors, to generate output image signals for the red, green, blue, and white pixels.

The output image signal of the white pixel includes a value defined by extracting portions of the light amount assigned to the red, green, and blue pixels, and so the output image signals of the red, green, and blue pixels have values defined by subtracting a light amount of the output image signal of the white pixel from the input image signals, respectively.

At this time, a luminance of an organic light emitting device (“OLED”) does not substantially increase. Thus, for improving the luminance, a technology that increases the light amount of the red, green, and blue pixels, respectively, has been developed.

However, in this case, currents flowing to the red, green, and blue pixels also increases, and thus, the magnitude of the total current increases, thereby decreasing efficiency.

### BRIEF SUMMARY OF THE INVENTION

In an exemplary embodiment, the present invention provides a display device including a plurality of pixels, a signal controller, and a data driver. The plurality of pixels respectively represent a first color, a second color, a third color, and white. According to an exemplary embodiment, the signal controller operates a white initial luminance value of the white and a first luminance compensation value, a second luminance compensation value and a third luminance compensation value of the first, second and third colors based on a first input image signal, a second input image signal and a third input image signal of the first, second and third colors, generates a white output signal of the white based on a sum of at least one portion of the first, second and third luminance compensation values and the white initial luminance value, and generates a first output image signal, a second output image signal, and a third output image signal of the first, second and third colors based on the remaining first, second and third luminance compensation values. According to an exemplary embodiment, the data driver converts the white output image signal and the first, second and third output image signals into data voltages and supplies the data voltages to the plurality of pixels, to display an image on the display device based on the data voltages.

According to an exemplary embodiment, the at least one portion of the first, second and third luminance compensation values may be defined by a luminance margin amount which is a difference between a white maximum luminance of the white and the white initial luminance value, and a luminance increment which is a minimum value of the first, second and third luminance compensation values.

According to an exemplary embodiment, when the luminance margin amount is more than the luminance increment, the at least one portion of the first, second and to third luminance compensation values may be the luminance increment.

According to an exemplary embodiment, when the luminance margin amount is less than or equal to the luminance increment, the at least one portion of the first, second and third luminance compensation values may be equal to the luminance margin amount.

According to an exemplary embodiment, the first, second and third luminance compensation values may be defined by a luminance compensation constant determined based on a luminance in a previous frame.

According to an exemplary embodiment, the luminance compensation constant may be defined by a frequency number of the first, second and third output image signals of a luminance larger than or equal to a threshold luminance in the previous frame.

According to an exemplary embodiment, the signal controller may include a signal processor which operates the white initial luminance value and a first initial luminance value, a second initial luminance value and a third initial luminance value of the first, second and third colors based on the white initial luminance value, and the first, second and third luminance compensation values may be defined by multiplying the first, second and third initial luminance values and the luminance compensation constant, respectively.

According to an exemplary embodiment, the signal processor may operate the first, second and third initial luminance values and the white initial luminance value based on luminances of the first, second and third input image signals, and the white initial luminance value may be defined as a minimum value of the luminances of the first, second and third input image signals.

According to an exemplary embodiment, the first, second and third initial luminance values may be defined by subtracting the white initial luminance value from the luminances of the first, second and third input image signals, respectively.

According to an exemplary embodiment, the first, second and third output image signals and the white output image signal may include luminance information satisfying the equations below:

Li′=Li−LWini+(Li×C−ΔW), LW′=LWini+ΔW

ΔW=min{Li×C, K}(i=1, 2, 3)

Herein, Li′ is a luminance of an output image signal of an i-th color, Li is a luminance of an input image signal of the i-th color, C is the luminance compensation constant, LW′ is a luminance of the white output image signal, LWini is the white initial luminance value, and K is the luminance margin amount.

According to an exemplary embodiment, the first, second and third colors may include three primary colors.

According to an exemplary embodiment, each of the pixels may include an organic light emitting element.

According to another exemplary embodiment, the present invention provides a driving method of a display device including receiving input image signals separately representing three primary colors, generating a luminance compensation constant based on a luminance of a previous frame, generating three initial luminance values of the three primary colors and a white initial luminance value of white based on the input image signals, operating luminance compensation values for the three primary colors in accordance with the luminance compensation constant, generating an output image signal of the white based on a sum of at least one portion of the luminance compensation values and the white initial luminance value, generating output image signals of the three primary colors based on the three initial luminance values and the remaining luminance compensation values, converting the output image signals into analog signals to generate data voltages, and displaying an image in accordance with the data voltages.

According to an exemplary embodiment, generating the output image signals may include defining the at least one portion of the luminance compensation values as a luminance increment when a luminance margin amount' which is a difference between a white maximum luminance of the white and the white initial luminance value is more than the luminance increment which is a minimum value of the luminance compensation values, and defining the at least one portion of the luminance compensation values as the luminance margin amount when the luminance margin amount is less than or equal to the luminance increment.

According to an exemplary embodiment, generating the luminance compensation constant may include determining the luminance compensation constant based on a frequency number of the output image signals of the three primary colors of a luminance larger than or equal to a threshold luminance in a previous frame.

According to an exemplary embodiment, generating the white initial luminance value and the three initial luminance values may include de-gamma converting the input image signals to generate luminance information for the three primary colors, arranging the luminance information based on a magnitude of luminance, defining a minimum value of the luminance information as the white initial luminance value, and defining a difference between the luminance information and the white initial luminance value as the three initial luminance values.

According to an exemplary embodiment, generating the luminance compensation values may include defining values obtained by multiplying the three initial luminance values and the luminance compensation constant as the luminance compensation values.

According to an exemplary embodiment, generating the output image signals may include generating a white luminance compensation value of the white by adding at least one portion of the luminance compensation values and the white initial luminance value, and generating the luminance compensation values by adding the three initial luminance values and the remaining luminance compensation values.

According to an exemplary embodiment, generating the output image signals may include converting the luminance compensation values into a threshold luminance, when the luminance compensation values are more than the threshold luminance, and de-gamma converting the luminance compensation values and the white luminance compensation value to generate the output image signals of the three primary colors and the white including gray information.

### BRIEF DESCRIPTION OF THE DRAWINGS

The above and/or other aspects, features, and advantages of the present invention will now become more apparent from the following detailed description when taken in conjunction with the accompanying drawings in which:

FIG. 1 is a block diagram showing an exemplary embodiment of an OLED according to the present invention;

FIG. 2 is an equivalent circuit diagram showing an exemplary embodiment of a pixel of an OLED according to the present invention;

FIG. 3 shows an exemplary embodiment of pixel arrangements of an OLED according to the present invention;

FIG. 4 is a graph representing an exemplary embodiment of a luminance conversion according to the present invention;

FIG. 5 is a block diagram showing an exemplary embodiment of a signal processor of a signal controller shown in FIG. 1, according to the present invention;

FIG. 6 is a flow chart showing an exemplary embodiment of an operation of the signal processor shown in FIG. 5 according to the present invention; and

FIGS. 7A through 7D are graphs showing an exemplary embodiment of experimental results of the present invention.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete and will fully convey the scope of the invention to those skilled in the art. In the drawings, the thickness of layers and regions are exaggerated for clarity. Like numerals refer to like elements throughout.

It will be understood that when an element such as a layer, film, region, substrate, or panel is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper”, and the like, are used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein may be interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross-section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. As an example, a region illustrated or described as flat may, typically, have rough and/or non-linear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be explained in detail with reference to the accompanying drawings.

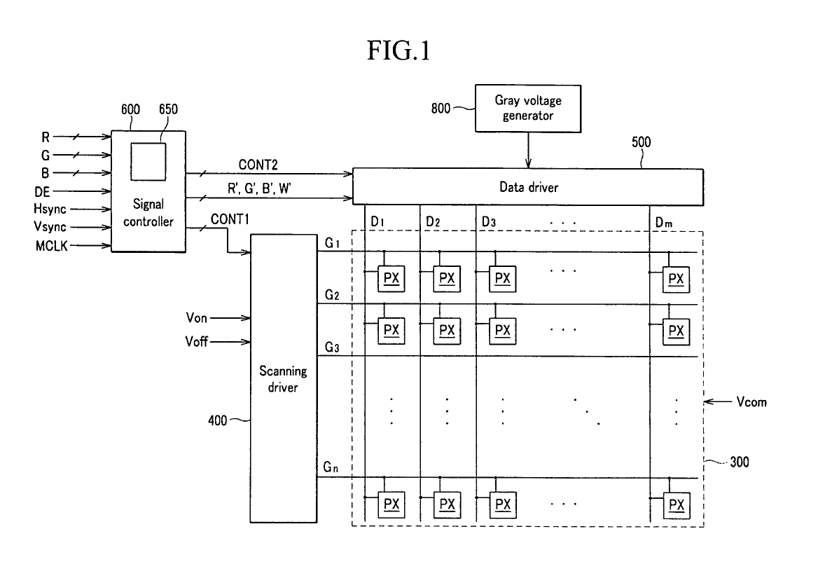

An OLED which is an example of display devices will now be described With reference to FIGS. 1 through 3.

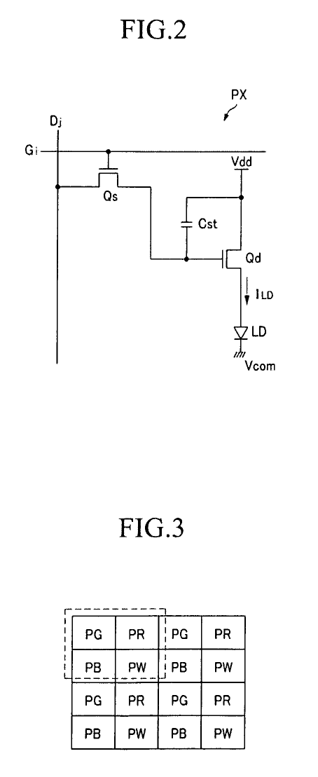

FIG. 1 is a block diagram showing an exemplary embodiment of an OLED according to the present invention, FIG. 2 is an equivalent circuit diagram showing an exemplary embodiment of a pixel of an OLED according to the present invention, and FIG. 3 shows an exemplary embodiment of pixel arrangements of an OLED according to the present invention.

Referring to FIG. 1, an OLED according to an exemplary embodiment includes a display panel 300, a scanning driver 400 and a data driver 500 which are connected to the display panel 300, a gray voltage generator 800 coupled to the data driver 500, and a signal controller 600 which controls the above elements.

According to an exemplary embodiment, the display panel 300 includes a plurality of signal lines G₁-Gₙ and D₁-Dₘ, a plurality of voltage lines (not shown), and a plurality of pixels PX connected to the signal lines G₁-Gₙ and D₁-Dₘ and the voltage lines and arranged substantially in a matrix, in a circuital view shown in FIG. 2.

According to an exemplary embodiment, the signal lines G₁-Gₙ and D₁-Dₘ include a plurality of scanning lines G₁-Gₙ which transmit scanning signals and a plurality of data lines D₁-Dₘ which transmit data signals. The scanning lines G₁-Gₙ extend substantially in a row direction and are substantially parallel to each other, while the data lines D₁-Dₘ extend substantially in a column direction and are substantially parallel to each other.

Referring to FIG. 2, each of the pixels PX, for example, a pixel PX in an i-th row (i=1, 2, . . . , n) and a j-th column (j=1, 2, . . . , m), is connected to a scanning line Gᵢ and a data line Dⱼ and includes an organic light emitting element LD, a driving transistor Qd, a capacitor Cst, and a switching transistor Qs.

According to an exemplary embodiment, the switching transistor Qs may be a thin film transistor (“TFT”) which includes three terminals such as a control terminal connected to a scanning line Gᵢ, an input terminal connected to the data line Dⱼ, and an output terminal connected to the driving transistor Qd. The switching transistor Qs transmits a data voltage in response to a scanning signal applied to the scanning line Gᵢ.

According to an exemplary embodiment, the driving transistor Qd may be a TFT which also includes three terminals such as a control terminal connected to the output terminal of the switching transistor Qs, an input terminal connected to a driving voltage Vdd, and an output terminal connected to the organic light emitting element LD. The driving transistor Qd flows an output current I_{LD}, including a magnitude defined based on a voltage, across the control terminal and the output terminal.

According to an exemplary embodiment, the capacitor Cst is connected between the control terminal and the input terminal of the driving transistor Qd. The capacitor Cst charges the data voltage applied to the control terminal of the driving transistor Qd through the switching transistor Qs and maintains the data voltage after the switching transistor Qs is turned off.

According to an exemplary embodiment, the organic light emitting element LD may be an organic light emitting diode, and the organic light emitting element LD includes an anode connected to the output terminal of the driving transistor Qd and a cathode connected to a common voltage Vcom. The organic light emitting element LD emits light including an intensity depending on the output current I_{LD} of the driving transistor Qd. The organic light emitting element LD uniquely represents one of the primary colors and white. An example of a set of the primary colors includes red, green, and blue, and a spatial sum of the primary colors represents a desired color. By adding white light to the synthesized light, a total luminance of the color increases.

According to an exemplary embodiment, alternatively, the organic light emitting elements LD of all pixels PX may emit white light. Therefore, according to an exemplary embodiment, some pixel PX may further include a color filter (not shown) that changes white light emitting from the organic light emitting element LD into one of the primary color lights.

Referring to FIG. 3, the pixels PX which emit lights of red, green, blue, and white are referred to as a red pixel PR, a green pixel PG, a blue pixel PB, and a white pixel PW, respectively and are arranged in a 2×2 matrix. According to an exemplary embodiment, when a pixel set which is arranged in this way is referred to as a “dot,” the OLED includes a structure in which the dots are repeatedly disposed in a row direction and a column direction.

According to an exemplary embodiment, in each dot, the red pixel PR is opposite to the blue pixel PB in a diagonal direction, and the green pixel PG is opposite to the white pixel PW in a diagonal direction. According to an exemplary embodiment, one dot includes a structure in which a green pixel PG and a white pixel PW face each other in a diagonal direction with respect to a color characteristic of the OLED.

According to an exemplary embodiment, the four color pixels PR, PG, PB, and PW may include a stripe arrangement or a pentile arrangement in addition to the checked arrangement of FIG. 3.

According to an exemplary embodiment, the switching transistor Qs and the driving transistor Qd are n-channel field effect transistors (“FETs”) including amorphous silicon or polysilicon. Alternatively, according to another exemplary embodiment, at least one of the transistors Qs and Qd may be a p-channel FET operating in a manner opposite to n-channel FETs. In addition, the connections of the transistors Qs and Qd, the capacitor Cst, and the OLED LD may be varied.

Referring to FIG. 1 again, the scanning driver 400 is connected to the scanning lines G₁-Gₙ of the display panel 300, and synthesizes a high voltage Von for turning on the switching transistors Qs and a low voltage Voff for turning off the switching transistors Qs, to generate scanning signals for application to the scanning lines G₁-Gₙ.

The data driver 500 is connected to the data lines D₁-Dₘ of the display panel 300 and applies data voltages to the data lines D₁-Dₘ.

The gray voltage generator 800 generates a plurality of gray voltage sets to output to the data driver 500. According to an exemplary embodiment, the gray voltage set may be different for each color based upon light emitting efficiency and lifetime of a light emitting material.

According the exemplary embodiment, the signal controller 600 controls the scanning driver 400 and the data driver 500, for example.

According to an exemplary embodiment, the signal controller 600 includes a signal processor 650 which generates four color output image signals R′, G′, B′, and W′ from three color input image signals R, G, and B. The signal processor 650 will be described in detail later.

According to an exemplary embodiment, the scanning driver 400, data driver 500, signal controller 600, and gray voltage generator 800 may each include at least one integrated circuit (“IC”) chip mounted on the display panel 300 or on a flexible printed circuit (“FPC”) film as a tape carrier package (“TCP”) type, which are attached to the display panel 300. According to another exemplary embodiment, at least one of the scanning driver 400, data driver 500, signal controller 600, and gray voltage generator 800 may be integrated with the display panel 300 along with the signal lines G₁-Gₙ, D₁-Dₘ and the transistors Qs and Qd. According to yet another exemplary embodiment, all the scanning driver 400, data driver 500, signal controller 600, and gray voltage generator 800 may be integrated into a single IC chip, but at least one of these elements or at least one circuit element of at least one of these elements may be disposed outside of the single IC chip.

An exemplary embodiment of an operation of the organic light emitting device of the present invention will now be described.

The signal controller 600 is supplied with the input image signals R, G, and B of three colors, such as red, green, and blue, and input control signals for controlling the display thereof from an external graphics controller (not shown). The input image signals R, G, and B are digital signals including a value (gray) corresponding to a luminance of each pixel PX based on the three colors, respectively. According to an exemplary embodiment, the number of grays may be, for example 1024(=2¹⁰), 256(=2⁸), or 64(=2⁶). A luminance represented by each gray is defined by a gamma curve of the display device, and converting the input image signals R, G, and B or the gray to a luminance is called “a gamma conversion”.

According to an exemplary embodiment, the input control signals include a vertical synchronization signal Vsync, a horizontal synchronization signal Hsync, a main clock signal MCLK, and a data enable signal DE.

After extracting an image signal of white from the input image signals R, G, and B of the three colors and modifying the input image signals R, G, and B, the signal controller 600 processes the input image signals R, G, and B and the extracted image signal of white to be suitable for the operation of the display panel 300 to generate output image signals R′, G′, B′, and W′ of four colors, for example red, green, blue, and white.

According to an exemplary embodiment, the signal controller 600 also generates scanning control signals CONT1 and data control signals CONT2 and transmits the scanning control signals CONT1 to the scanning driver 400 and the data control signal CONT2 and the processed output image signals R′, G′, B′, and W′ to the data driver 500.

According to an exemplary embodiment, the scanning control signals CONT1 may include a scanning start signal STV for instructing to start scanning and at least one clock signal for controlling the output time of the high voltage Von. The scanning control signals CONT1 may further include an output enable signal OE for defining the duration of the high voltage Von.

According to an exemplary embodiment, the data control signals CONT2 may include a horizontal synchronization start signal STH for informing of start of transmission of the output image signals R′, G′, B′, and W′ for a row of pixels PX, a load signal LOAD for instructing to apply the data voltages to the data lines D₁-Dₘ, and a data clock signal HCLK.

In response to the data control signals CONT2 from the signal controller 600, the data driver 500 receives a packet of the output image signals R′, G′, B′, and W′ for the row of pixels PX, and converts the digital output image signals R′, G′, B′, and W′ into analog data voltages.

The scanning driver 400 applies the high voltage Von to a scanning line G₁-Gₙ in response to the scanning control signals CONT1 from the signal controller 600, thereby turning on the switching transistors Qs connected to the scanning line G₁-Gₙ.

Accordingly, the switching transistors Qs of the corresponding pixel row are turned on and the driving transistors Qd receive the corresponding data voltages through the turned-on switching transistors Qs. Each driving transistor Qd outputs a driving current I_{LD} corresponding to the applied data voltage to the organic light emitting element LD. Accordingly, the organic light emitting element LD emits light of a magnitude corresponding to the driving current I_{LD}.

By repeating the process with a unit of one horizontal period (which is also referred to as “1H”, and is equal to one period of a horizontal synchronizing signal Hsync and a data enable signal DE), all of the scanning lines G1-Gn are sequentially supplied with the high voltage Von, thereby applying the voltages to all pixels PX to display an image of a frame.

According to an exemplary embodiment, the OLED increases luminances of the input image signals R, G, and B in the same ratio, respectively, to increase brightness of an image.

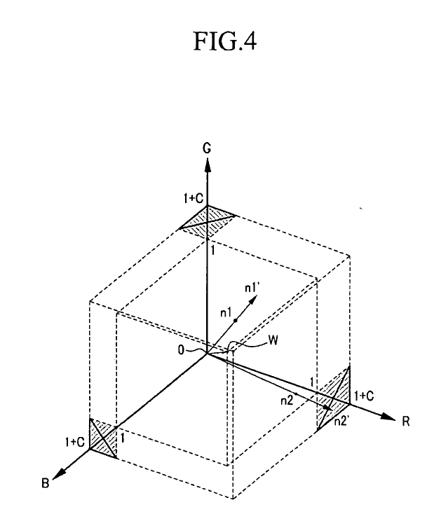

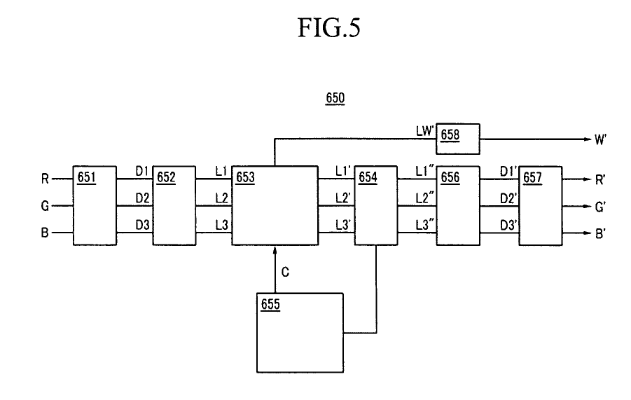

FIG. 4 is a graph representing an exemplary embodiment of a luminance conversion according to the present invention.

In FIG. 4, a luminance space includes an x-axis, a y-axis, and a z-axis, and each of the x-axis, the y-axis, and the z-axis represents one of the red, green, and blue colors. Each coordinate of the luminance space represents a normalized luminance.

According to an exemplary embodiment, when the input image signals R, G, and B are about 8-bit signals, a gray and a luminance represented by one image signal R, G, and B include a total of 256 steps from 0 through 255, respectively. When each of the total 256 steps is normalized by the 255-th step, on which the maximum luminance is represented, the respective 256 steps from 0 to 255 are sequentially 0, 1/255, 2/255, . . . , 254/255, and 1.

Thus, luminances of all the input image signals R, G, and B are positioned in the luminance space of a regular hexagon. At this time, the regular hexagon has apexes of (0, 0, 0), (1, 0, 0), (0, 1, 0), (0, 0, 1), (1, 1, 0), (1, 0, 1), (0, 1, 1), and (1, 1, 1). At this time, all points on the longest straight line which is connected from the starting point (0, 0, 0) to the apex (1, 1, 1) represent white.

In order to improve the brightness of an image, the normalized luminance space of the regular hexagon is enlarged by about 1+C. That is, each of the luminances represented by all the input image signals R, G, and B is enlarged by about 1+C.

According to an exemplary embodiment, a point n1 of a luminance represented by combination of the input image signals R, G, and B of the red, green, and blue colors is changed to n1′. At this time, a distance from the starting point (0, 0, 0) to the point n1′ is a distance that has (1+C) added to a distance between the starting point (0, 0) and the point n1 along a straight line from the point n1 to the starting point (0, 0, 0). Thus, each coordinate of the changed point n1′ becomes about (1+C) times to that of the point n1, and it means that a luminance of each color increases about (1+C) times.

Here, “C” is a luminance compensation constant for determining a luminance increment, and a value of the constant C is defined as in the description below.

However, pure colors such as red, green, and blue are input image signals adjacent to each axis and have rather small luminance increments. As one example, a point n2 that is indicated by the input image signals R, G, and B of the three colors should be changed to a point n2′, but the point n2′ is positioned in a representation impossible region (hatched portions in FIG. 4) of the display device. Thus, in this case, a separate conversion is performed to position the changed point n2′ in a representation possible region. For example, by varying the luminance compensation constant C of a point positioned in the representation impossible region, the point may be moved to the representation possible region.

Next, referring to FIGS. 5 through 7D, the OLED for improving efficiency as well as a luminance thereof will be described.

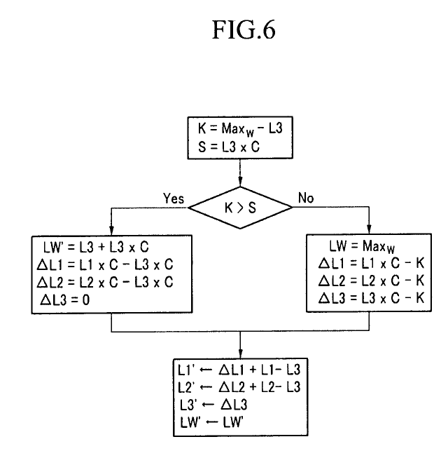

FIG. 5 is a block diagram showing an exemplary embodiment of a signal processor according to the present invention, and FIG. 6 is a flow chart showing an exemplary embodiment of an operation of the signal processor shown in FIG. 5 according to the present invention.

The OLED according to an exemplary embodiment of the present invention includes the signal processor 650, as described above.

Referring to FIG. 5, the signal processor 650 includes a first signal ordering unit 651, a gamma converter 652, a calculator 653, a clipping unit 654, a luminance compensation constant calculator 655, a three-color de-gamma converter 656, a second signal ordering unit 657, and a white de-gamma converter 658. The signal processor 650 is supplied with a plurality of groups of three color input image signals R, G, and B from an external device (not shown) and generates one white output image signal W′ for a white pixel WP and three color output image signals R′, G′, and B′ for red, green, and blue pixels PR, PG, and PB based on each group of three color input image signals R, G, and B.

The first signal ordering unit 651 is supplied with the plurality of groups of three color input image signals R, G, and B and arranges the three color input image signals R, G, and B included in each group of three color input image signals R, G and B based on grays thereof. According to an exemplary embodiment, the arrangement order may be in order of magnitude of the grays of the respective input image signals R, G, and B. For example, the three color input image signals may be arranged in descending power of the grays.

According to an exemplary embodiment, when the three color input image signals R, G, and B are arranged in descending power of the grays, it is assumed that a first signal D1, a second signal D2, and a third signal D3 are sequentially defined from the input image signal R, G, and B of the largest gray to the input image signal R, G, and B of the smallest gray of the three color input image signals R, G, and B. In addition, grays of the first, second, and third signals D1-D3 are sequentially referred to as a first gray, a second gray, and a third gray.

The gamma converter 652 gamma-converts the first, second to and third signals D1-D3 to generate a first luminance signal L1, a second luminance signal L2 and a third luminance signal L3, respectively. The luminance signals L1-L3 include a first luminance, a second luminance, and a third luminance corresponding to the first through third grays, respectively.

The calculator 653 generates a white luminance signal LW′ based on the first, second and third luminance signals L1-L3 and the luminance compensation constant C and converts the first, second- and third luminance signals L1-L3 to a first luminance compensation signal L1′, a second luminance compensation signal L2′ and a third luminance compensation signal L3′, respectively.

Referring to FIG. 6, an operation of the calculator 653 which generates the white luminance signal LW′ and the first, second and third luminance compensation signals L1′-L3′ will be described.

According to an exemplary embodiment, the calculator 653 may define the third luminance signal L3 of the three luminance signals L1, L2, and L3, which includes the smallest gray, as a white initial signal LWᵢₙᵢ, and may define first, second and third initial luminance signals L1ᵢₙᵢ, L2ᵢₙᵢ, and L3ᵢₙᵢ by subtracting the gray of the white initial signal LWᵢₙᵢ from the first, second and third luminance signals L1-L3, respectively. Therefore, the first initial luminance signal L1ᵢₙᵢ may include a value obtained by subtracting the third luminance from the first luminance, the second initial luminance signal L2ᵢₙᵢ may include a value obtained by subtracting the third luminance from the second luminance, and the third initial luminance signal L3ᵢₙᵢ may be 0.

In addition, according to an exemplary embodiment, the calculator 653 receives the luminance compensation constant C from the luminance compensation constant calculator 655 and multiplies the first, second and third luminance signals L1-L3 by the luminance compensation constant C, respectively, to define first, second and third initial luminance compensation values ΔL1ᵢₙᵢ, ΔL2ᵢₙᵢ, and ΔL3ᵢₙᵢ.

Therefore, the first, second and third initial luminance compensation values ΔL1ᵢₙᵢ, ΔL2ᵢₙᵢ, and ΔL3ᵢₙᵢ satisfy the below Equation 1.

ΔL1ᵢₙᵢ=L1×C, ΔL2ᵢₙᵢ=L2×C, ΔL3ᵢₙᵢ=L3×C [Equation 1]

Next, the calculator 653 generates the white luminance signal LW′ and the first, second and third luminance compensation signals L1′-L3′ in accordance with operations of the flowchart shown in FIG. 6. At this time, efficiency of the white luminance signal LW′ and the first, second and third luminance compensation signals L1′, L2′, and L3 is compensated.

Red, green, and blue pixels PR, PG, and PB display white light by the third initial luminance compensation value ΔL3ᵢₙᵢ having the minimum of the first, second and third initial luminance compensation values ΔL1ᵢₙᵢ, ΔL2ᵢₙᵢ, and ΔL3ᵢₙᵢ. Thereby, a white light amount of luminances r, g, b, and w of the red, green, and blue pixels PR, PG, and PB increased by the luminance compensation constant C is the same as the third initial luminance compensation value ΔL3ᵢₙᵢ, and hereinafter the white light amount is referred to as a white luminance increment S.

Meanwhile, the maximum luminance represented by the white pixel PW is called the white maximum luminance Max_{w}. Since the white initial signal LWᵢₙᵢ includes a luminance (‘a third luminance’) of the third signal L3, the white pixel PW includes a white luminance margin amount K corresponding to a difference between the white maximum luminance Max_{w} and the third luminance, as compared to the luminance of the white initial signal LWᵢₙᵢ.

The calculator 653 compares the white luminance increment S and the white luminance margin amount K, and generates the white luminance signal LW′ and the first, second and third luminance compensation signals L1′-L3′ based on the comparison result.

According to an exemplary embodiment, when the white luminance margin amount K is larger than the white luminance increment S, the calculator 653 operates the white luminance signal LW′ by adding the white initial signal LWᵢₙᵢ and the white luminance increment S. The calculator 653 also defines differences between the first, second and third initial luminance compensation values ΔL1ᵢₙᵢ, ΔL2ᵢₙᵢ, and L3ᵢₙᵢ and the white luminance increment S as first, second and third luminance compensation values ΔL1, ΔL2, and ΔL3, respectively.

Thus, the first, second and third luminance compensation values ΔL1-ΔL3 satisfy Equation 2, below.

ΔL1=ΔL1ᵢₙᵢ−S, ΔL2=ΔL2ᵢₙᵢ−S, ΔL3=ΔL3ᵢₙᵢ−S [Equation 2]

At this time, the third luminance compensation value ΔL3 is about 0.

In the meantime, when the white luminance margin amount K is equal to or less than the white luminance increment S, the calculator 653 defines the white maximum luminance Max_{w} as a luminance of the white luminance signal LW′, and operates the first, second and third luminance compensation values ΔL1-ΔL3 to satisfy Equation 3.

ΔL1=ΔL1ᵢₙᵢ−K, ΔL2=ΔL2ᵢₙᵢ−K, ΔL3=ΔL3ᵢₙᵢ−K [Equation 3]

That is, when the white luminance increment S is larger than the white luminance margin amount K, the white luminance increment S is divided into white light represented by combination of the red, green, and blue pixels PR, PG, and PB and white light of the white pixel PW.

Therefore, when white light corresponding to the white luminance increment S is represented, currents flowing through the red, green, and blue pixels PR, PG, and PB are minimized to reduce consumption power of the red, green, and blue pixels PR, PG, and PB.

The calculator 653 adds the first, second- and third luminance compensation values ΔL1, ΔL2, and ΔL3 of Equation 2 or Equation 3 to the first, second and third initial luminance signals L1ᵢₙᵢ, L2ᵢₙᵢ, and L3ᵢₙᵢ to define the first, second and third luminance compensation signals L1′, L2′, and L3′, respectively. In addition, the calculator 653 adds the white luminance compensation values ΔLW to the white initial luminance signals LWᵢₙᵢ to define the white luminance signal LW1′.

That is, the first, second and third luminance compensation signals L1′-L3′ and the white luminance signal LW′ satisfy Equation 4.

Li′=Li−LWᵢₙᵢ+(Li×C−ΔW), (i=1, 2, 3), LW′=LWᵢₙᵢ+ΔW. [Equation 4]

At this time, ΔW=min{S, K}, that is, ΔW includes the minimum value between the white luminance increment S, that is, the third initial luminance compensation value ΔL3ᵢₙᵢ of the first, second and- third initial luminance compensation values ΔL1ᵢₙᵢ, ΔL2ᵢₙᵢ, and ΔL3ᵢₙᵢ and the white luminance margin amount K.

The calculator 653 outputs the first, second and third luminance compensation signals L1′, L2′, and L3′ to the clipping unit 654, and outputs the white luminance signal LW′ to the white de-gamma converter 658.

Referring to FIG. 5 again, the clipping unit 654 receives the first, second and third luminance compensation signals L1′-L3′ from the calculator 653, and compares luminances of the luminance compensation signals L1′-L3′ and a threshold luminance (not shown), respectively.

According to an exemplary embodiment, when there is a luminance compensation signal including a luminance more than the threshold luminance, the clipping unit 654 changes the luminance of the luminance compensation signal into the threshold luminance to generate first, second and third output luminance signals L1″, L2″, and L3″.

According to an exemplary embodiment, the threshold luminance may be defined as a minimum value of the maximum luminance of each of the red, green and blue pixels PR, PG, and PB. Alternatively, according to an exemplary embodiment, a plurality of threshold luminances having different values with respect to each color may be used.

The luminance compensation constant calculator 655 counts frequency of the first, second and third luminance compensation signals L1′, L2′, and L3′ including a luminance more than the threshold luminance for every predetermined period, for example one frame unit.

The luminance compensation constant calculator 655 determines the luminance compensation constant C based on a compensation luminance signal frequency number of the first, second and third luminance compensation signals L1′, L2′, and L3′ counted for a previous frame to output it to the calculator 653. According to an exemplary embodiment, when the compensation luminance signal frequency number of the previous frame is large, the determined luminance compensation constant C becomes larger, and when the compensation luminance signal frequency number of the previous frame is small, the determined luminance compensation constant C becomes smaller. According to an exemplary embodiment, the luminance compensation constant C may be determined as a function of the compensation luminance signal frequency number function, and the luminance compensation constant calculator 655 may include a look-up table storing values of the luminance compensation constant C with respect to the compensation luminance signal frequency number.

The three-color de-gamma converter 656 de-gamma converts the first, second and third output luminance signals L1″-L3″ received from the clipping unit 654 using a gamma function to generate first, second and third output gray signals D1′-D3′.

The second signal ordering unit 657 rearranges the first, second and third output gray signals D1′-D3′ in accordance with color information, that is, color, and defines the rearranged output gray signals D1′-D3′ as three color output image signals R′, G′, and B′ of the red, green, and blue, respectively. According to an exemplary embodiment, the rearrangement order of the output gray signals D1′-D3′ is red, green, and blue, but it may be varied.

According to an exemplary embodiment, the three-color de-gamma converter 656 may perform the de-gamma conversion using a plurality of gamma functions that are different for every color, instead of one gamma function. In the current exemplary embodiment, the three-color de-gamma converter 656 rearranges the first, second and third output luminance signals L1″-L3″ in accordance with the color information, and de-gamma converts them based on the gamma functions that are respectively defined with respect to the respective color to generate the three color output image signals R′, G′, and B′.

According to an exemplary embodiment, the white de-gamma converter 658 de-gamma converts the white luminance signal LW to generate the white output image signal W′.

According to an exemplary embodiment, the signal processor 650 outputs the three color output image signals R′, G′, and B′ and the white output image signal W′ to the data driver 500.

Next, effects of the embodiment of the present invention will be described referring to various experiments.

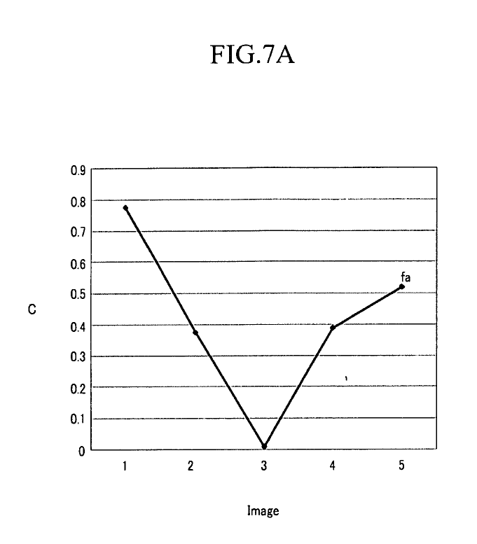

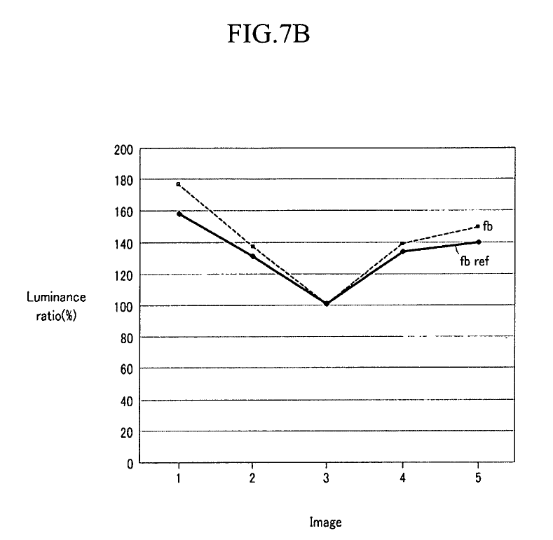

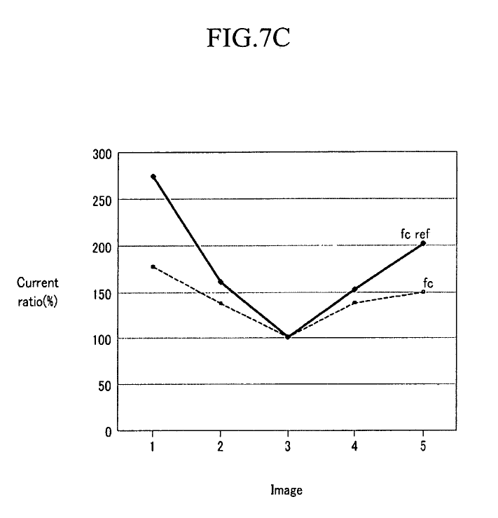

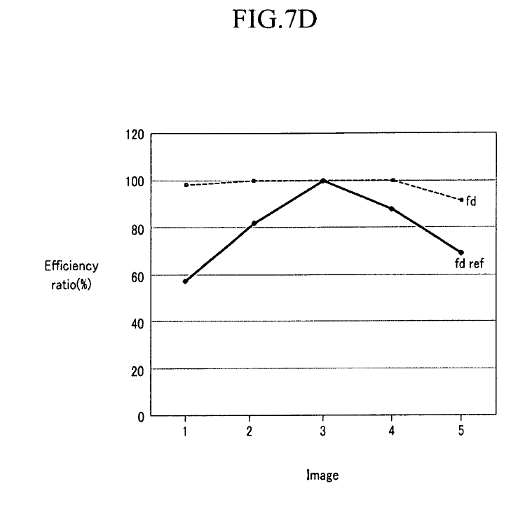

FIGS. 7A through 7D are graphs according to an exemplary embodiment of experimental results of the present invention.

In Table 1, five image display conditions are described. Under the five image display conditions, a luminance compensation constant C, luminance, a current, and efficiency according to the embodiment of the present invention based on two control groups were measured.

TABLE 1

| Image | Image display condition |
|---|---|
| 1 | A case where there are few pixels of pure white having a |
| | high luminance. |
| 2 | A case where there is a large number of pixels having not |
| | pure white but a high luminance. |
| 3 | A case where there is a large number of pixels of pure |
| | white having a high luminance. |
| 4 | A case where there is a large number of pixels of pure |
| | white but having a low luminance. |
| 5 | A case where there is a large number of pixels of white |
| | color having a high luminance. |

A first control group of the two control groups is a case where an image is displayed by de-gamma converting the white initial signal LWᵢₙᵢ and the first, second and third initial luminance signals L1ᵢₙᵢ, L2ᵢₙᵢ, and L3ᵢₙᵢ, and a second control group of the two control groups is a case that an image is displayed by de-gamma converting the white initial signal LWᵢₙᵢ and three signals obtained by adding the first, second and third initial luminance compensation values ΔL1ᵢₙᵢ, ΔL2ᵢₙᵢ, and ΔL3ᵢₙᵢ to the first to third initial luminance signals L1ᵢₙᵢ, L2ᵢₙᵢ, and L3ᵢₙᵢ, respectively.

As shown in FIG. 7A, a value of the compensation constant C is defined according to the five image display conditions.

That is, when an image is the first image 1 which is the darkest, since a luminance compensation value is large, the value of the compensation constant C is large. When an image is the third image 3, since there are many pixels PX of pure colors having a high luminance, that is, near the threshold luminance, the value of the compensation luminance C is small. In addition, when an image is the fifth image 5, since there are few input image signals corresponding to the red, green, and blue pixels PR, PG, and PB near the threshold luminance. Therefore, even though the image 5 includes high luminance, the value of the luminance compensation constant C is relatively large.

FIGS. 7B through 7D show two graphs f and f_{ref}, respectively. In the two graphs f and f_{ref}, the first graph f is the result to the first control group, and the second graph f_{ref} is the result of the second control group.

FIG. 7B shows a luminance ratio with respect to each image 1-5. Since the luminance compensation constant C in FIG. 7A includes a value more than 0, a luminance of each image 1-5 increases before a luminance compensation operation. In addition, since the first graph fb and the second graph fb_{ref} increase luminances based on the same luminance compensation constant C, respectively, the first graph fb and the second graph fb_{ref} have a similar pattern to each other. For reference, the luminance compensation constant C is about 0 and a luminance ratio is about 100%. In addition, the luminance ratio is varied in accordance with a value of the luminance compensation constant C, and as the value of the luminance compensation constant C increases, the luminance ratio becomes larger.

However, in observing the first and second graphs fc and fc_{ref} of FIG. 7C with respect to a current ratio, the second graph fc_{ref} includes a current ratio larger than that of the first graph fc. In observing an efficiency ratio of FIG. 7D, the first graph fd has an efficiency ratio of almost 100%, and thereby it is seen that the embodiment maintains efficiency similar to that of a case without luminance compensation. However, the efficiency ratio of the second graph fd_{ref} is much less than that of the first graph fd, and a difference between the efficiency ratio of the first graph fd and the second graph fd_{ref} becomes larger as the luminance compensation constant C increases.

According to an exemplary embodiment, a luminance value for compensating a luminance is distributed not in red, green, and blue pixels, but rather in white pixels to increases a luminance of an image, and consumption power of the display device is reduced to improve efficiency of the display device, as well.

While the present invention has been shown and described with reference to some exemplary embodiments thereof, it should be understood by those of ordinary skill in the art that various changes in form and details may be made therein without departing from the spirit and scope of the present invention as defined by the appended claims.

What is claimed is:

1. A display device comprising:
a plurality of pixels which represent a first color, a second color, a third color, and white;
a signal controller which operates a white initial luminance value of the white and a first luminance compensation value, a second luminance compensation value and a third luminance compensation value of the first, second and third colors based on a first input image signal, a second input image signal and a third input image signal of the first, second and third colors, generates a white output image signal of the white based on a sum of at least one portion of the first, second and third luminance compensation values and the white initial luminance value, and generates a first output image signal, a second output image signal and a third output image signal of the first, second and third colors based on the remaining first, second and third luminance compensation values; and
a data driver which converts the white output image signal and the first, second and third output image signals into data voltages and supplies the data voltages to the pixels, to display an image on the display device based on the data voltages.

2. The display device of claim 1, wherein the at least one portion of the first, second and third luminance compensation values is defined by a luminance margin amount which is a difference between a white maximum luminance of the white and the white initial luminance value and a luminance increment which is a minimum value of the first, second and third luminance compensation values.

3. The display device of claim 2, wherein, when the luminance margin amount is more than the luminance increment, the at least one portion of the first, second and third luminance compensation values is the luminance increment.

4. The display device of claim 2, wherein, when the luminance margin amount is less than or equal to the luminance increment, the at least one portion of the first, second and third luminance compensation values is the equal to the luminance margin amount.

5. The display device of claim 1, wherein the first, second and third luminance compensation values are defined by a luminance compensation constant determined based on a luminance in a previous frame.

6. The display device of claim 5, wherein the luminance compensation constant is defined by a frequency number of the first, second and third output image signals of a luminance larger than or equal to a threshold luminance in the previous frame.

7. The display device of claim 6, wherein the signal controller comprises a signal processor which operates the white initial luminance value and operates a first initial luminance value, a second initial luminance value and a third initial luminance value of the first, second and third colors based on the white initial luminance value, and the first, second and third luminance compensation values are defined by multiplying the first, second and third initial luminance values and the luminance compensation constant, respectively.

8. The display device of claim 7, wherein the signal processor operates the first, second and third initial luminance values and the white luminance value based on luminances of the first, second and third input image signals, and the white initial luminance value is defined as a minimum value of the luminances of the first, second and third input image signals.

9. The display device of claim 8, wherein the first, second and third initial luminance values are defined by subtracting the white initial luminance value from the luminances of the first, second and third input image signals, respectively.

10. The display device of claim 9, wherein the first, second and third colors are three primary colors.

11. The display of claim 2, wherein the first, second and third output image signals and the white output image signal include luminance information satisfying equations below:
Li′=Li−LWini+(Li×C−ΔW), LW′=LWini+ΔW.
ΔW=min{Li×C, K}(i=1, 2, 3),
wherein, Li′ is a luminance of an output image signal of an i-th color, Li is a luminance of an input image signal of the i-th color, C is the luminance compensation constant, LW′ is a luminance of the white output image signal, LWini is the white initial luminance value, and K is the luminance margin amount.

12. The display device of claim 11, wherein the first, second and third colors are three primary colors.

13. The display device of claim 1, wherein each of the pixels comprises an organic light emitting element.

14. A driving method of a display device, the method comprising:
receiving input image signals separately representing three primary colors;
generating a luminance compensation constant based on a luminance of a previous frame;
generating three initial luminance values of the three primary colors and a white initial luminance value of white based on the input image signals;
operating luminance compensation values for the three primary colors in accordance with the luminance compensation constant;
generating an output image signal of the white based on a sum of at least one portion of the luminance compensation values and the white initial luminance value;
generating output image signals of the three primary colors based on the three initial luminance values and the remaining luminance compensation values;
converting the output image signals into analog signals to generate data voltages; and
displaying an image in accordance with the data voltages.

15. The method of claim 14, wherein generating the output image signals comprises:
defining the at least one portion of the luminance compensation values as a luminance increment when a luminance margin amount which is a difference between a white maximum luminance of the white and the white initial luminance value, is more than the luminance increment which is a minimum value of the luminance compensation values; and
defining the at least one portion of the luminance compensation values as the luminance margin amount when the luminance margin amount is less than or equal to the luminance increment.

16. The method of claim 15, wherein generating the luminance compensation constant comprises determining the luminance compensation constant based on a frequency number of output image signals of the three primary colors of luminance larger than or equal to a threshold luminance in a previous frame.

17. The method of claim 16, wherein generating the white initial luminance value and the three initial luminance values comprises:
de-gamma converting the input image signals to generate luminance information for the three primary colors;
arranging the luminance information based on a magnitude of luminance;
defining a minimum value of the luminance information as the white initial luminance value; and
defining a difference between the luminance information and the white initial luminance value as the three initial luminance values.

18. The method of claim 17, wherein generating the luminance compensation values comprises defining values obtained by multiplying the three initial luminance values and the luminance compensation constant as the luminance compensation values.

19. The method of claim 18, wherein generating the output image signals comprises:
generating a white luminance compensation value of the white by adding at least one portion of the luminance compensation values and the white initial luminance value; and
generating the luminance compensation values by adding the three initial luminance values and the remaining luminance compensation values.

20. The method of claim 19, wherein generating the output image signals further comprises:
converting the luminance compensation values into a threshold luminance when the luminance compensation values are more than the threshold luminance; and
de-gamma converting the luminance compensation values and the white luminance compensation value to generate the output image signals of the three primary colors and the white including gray information.
